(19) United States
(12) Patent Application Publication
(10) Pub. No.: US 2026/0139483 A1
(43) Pub. Date: May 21, 2026

(54) PRETENSIONED SANDWICH PANEL WITH INTEGRATED FIBER CONNECTOR

(71) Applicant: CCS Contractor Equipment & Supply, LLC, Melrose Park, IL (US)

(72) Inventor: Marinus Hansort, St. Pete Beach, FL (US)

(73) Assignee: CCS Contractor Equipment & Supply, LLC, Melrose Park, IL (US)

(21) Appl. No.: 19/391,246

(22) Filed: Nov. 17, 2025

Related U.S. Application Data
(60) Provisional application No. 63/720,995, filed on Nov. 15, 2024.

(51) Int. Cl. E04C 2/288; B32B 13/04; E04C 5/08

(52) U.S. Cl. CPC E04C 2/288; B32B 13/04; E04C 5/08; B32B 2250/40; B32B 2307/304; B32B 2419/00

(57) ABSTRACT

A concrete sandwich panel includes a first reinforced concrete layer, a second reinforced concrete layer, an insulating layer disposed between the first reinforced concrete layer and the second reinforced concrete layer, and an elongated tie member. The insulating layer includes a first panel and a second panel that are divided by a vertical seam. The elongated tie member includes a wave shape comprising crests and troughs. A wave height of the tie member is configured for the troughs to extend into the first reinforced concrete layer and the crests to extend into the second reinforced layer. The elongated tie member is disposed in the vertical seam with at least one of the first or second panels compressed around the elongated tie member to maintain contact of the first and second panels along the vertical seam.

### CROSS-REFERENCE TO RELATED APPLICATION

This application claims the benefit and priority under 35 U.S.C §119(e) to U.S. Provisional Patent Application No. 63/720,995, filed November 15, 2024, the content of which is incorporated herein by reference in its entirety.

### TECHNICAL FIELD

The present disclosure relates generally to the field of anchors for sandwich panels of pre-case concrete for use in construction, and more specifically to a pretension sandwich panel with an integrated fiber connector, assemblies, subassemblies, and components thereof.

### BACKGROUND

Pre-cast concrete sandwich panels are construction panels comprising two wythes or concrete layers having a layer of insulation sandwiched therebetween. Typically, the concrete layers are reinforced and tied together across and to the insulation layer with trusses or ties or anchors. In some examples, the concrete layers are reinforced with a grid material. It would be beneficial to have an improved integrated fiber connector for reinforcing and connecting the concrete layers through more efficient manufacturing methods.

### SUMMARY

According to the disclosure, a concrete sandwich panel includes a first reinforced concrete layer, a second reinforced concrete layer, an insulating layer disposed between the first reinforced concrete layer and the second reinforced concrete layer, and an elongated tie member. The insulating layer includes a first panel and a second panel that are divided by a vertical seam. The elongated tie member includes a wave shape comprising a plurality of crests and a plurality of troughs. A wave height of the tie member is configured for the plurality of crests to extend into the first reinforced concrete layer and the plurality of troughs to extend into the second reinforced layer. The elongated tie member is disposed in the vertical seam with at least one of the first or second panels compressed around the elongated tie member to maintain contact of the first and second panels along the vertical seam.

Also, according to the disclosure, an anchoring system for a reinforced concrete sandwich panel includes a first layer of concrete provided with a first reinforcing rod and a second layer of concrete provided with a second reinforcing rod, a tie member and an insulation layer disposed between the first layer of concrete and the second layer of concrete. The tie member has a sinusoidal shape extending at least into the first layer of concrete and the second layer of concrete. The insulation layer has a first insulating panel extending along the length of a tie member on a first side and a second insulating panel extending along the length of a tie member on a second side, opposite the first side. The tie member includes at least one attachment structure securing the tie member to the first reinforcing rod or the second reinforcing rod.

Further, according to the disclosure, a method for producing a concrete sandwich panel includes compressing a first insulating panel along a first side of a tie member and a second insulating panel along a second side of a tie member to produce an insulating tie layer, attaching a bottom reinforcing structure and a top reinforcing structure to the tie member, pouring a first layer of concrete into a mold, disposing the insulating tie layer on top of the first layer of concrete and positioning the bottom reinforcing structure in the first layer of concrete to produce a first reinforced concrete layer, and pouring a second layer of concrete on top of the insulating tie member and positioning the top reinforcing structure in the second layer of concrete to produce a second reinforced concrete layer.

Implementations of the disclosure may include one or more of the preceding features in various combinations. The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is an upper perspective view of a concrete sandwich panel with a section cutaway to show a tie member.

FIG. 2 is an upper perspective view of the concrete sandwich panel of FIG. 1 with the concrete and insulating layer shown in phantom lines.

FIG. 3 is an exploded perspective view of the elongated tie member, the pre-stressed cables, and attachment structures shown in FIG. 2.

FIG. 4 is an end view of the concrete sandwich panel of FIG. 1.

FIG. 5 is a side view of the elongated tie member, the pre-stressed cables, and attachment structures shown in FIG. 2.

FIG. 6 is an end view of the elongated tie member of FIG. 5.

FIG. 7 is a side view of an additional example of an elongated tie member.

FIG. 8 is an end view of the elongated tie member of FIG. 7.

FIG. 9 is a side view of an elongated tie member with an additional example of attachment structures.

FIG. 10 is an end view of the elongated tie member of FIG. 9.

FIG. 11 is a side view of an elongated tie member with an additional example of attachment structures.

FIG. 12 is an end view of the elongated tie member of FIG. 11.

FIG. 13 is a side view of an elongated tie member with an additional example of attachment structures.

FIG. 14 is an end view of the elongated tie member of FIG. 13.

FIG. 15 is an upper perspective view of a concrete sandwich panel with the concrete and insulating layer shown in phantom lines.

FIG. 16 is an upper perspective view of the concrete sandwich panel of FIG. 15 with the concrete shown in phantom lines.

FIG. 17 is an end view of the concrete sandwich panel of FIG. 16.

FIG. 18 is a flow chart illustrating the method of producing a reinforced concrete panel.

Like reference numerals indicate like parts throughout the drawings.

### DETAILED DESCRIPTION

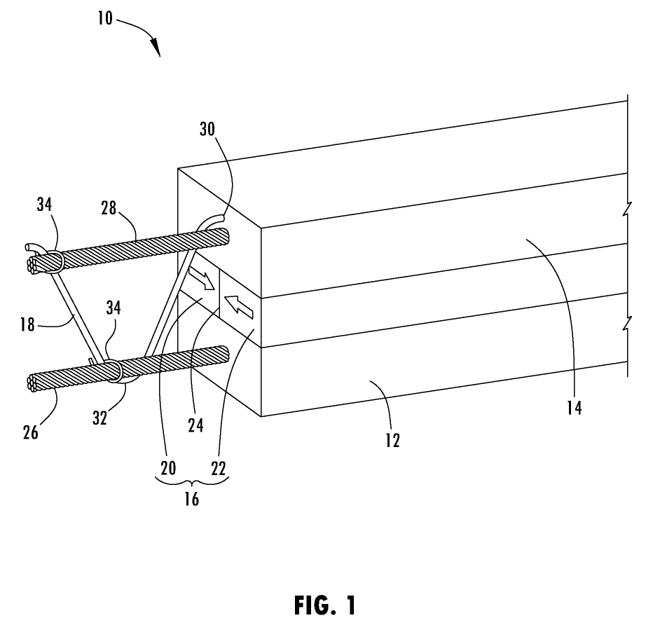

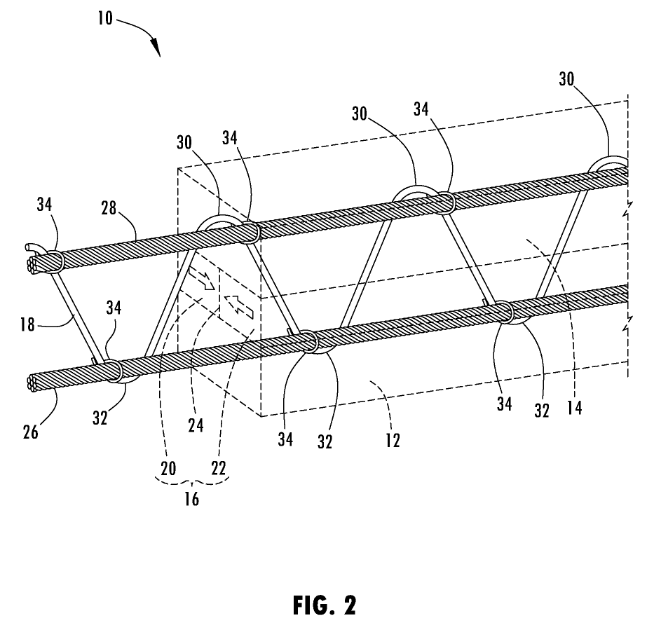

Embodiments shown in the drawings and described herein provide a concrete sandwich panel and an anchoring system for reinforcing the concrete sandwich panel. Referring to FIGS. 1 and 2, an exemplary concrete sandwich panel 10 is illustrated. The sandwich panel 10 includes a first layer of concrete 12 and a second layer of concrete 14 separated by an insulating layer 16. The insulating layer 16 may have of an elongated tie member 18 surrounded by a first insulating panel 20 and a second insulating panel 22. The first and second insulating panels 20, 22 may be compressed against each other defining a vertical seam 24 between the insulating panels 20, 22. The first insulating panel 20 may be compressed along a first side of the elongated tie member 18 and the second insulating panel 22 may be compressed along a second side of the elongated tie member 18, resulting in the elongated tie member 18 being disposed at least partially in the vertical seam 24. The sandwich panel 10 includes a first reinforcing structure 26, which may be configured as a pre-stressed cable, such as shown in FIGS. 1 and 2. The first reinforcing structure 26 is disposed at least partially in the first layer of concrete 12 and extends throughout the length of the first layer of concrete 12. As shown in FIGS. 1 and 2, the sandwich panel 10 may also include a second reinforcing structure 28 configured as a pre-stressed cable. The second reinforcing structure 28 may be disposed at least partially in the second layer of concrete 14 and may extend throughout the length of the second layer of concrete 12.

In some examples, the sandwich panel 10 may include at least one elongated tie member 18 extending along the length of the sandwich panel 10. In other examples, the sandwich panel 10 may include two or more elongated tie members which may be connected or otherwise disposed end-to-end to extend the length of reinforcement in a sandwich panel. The elongated tie member 18 may be comprised of a fiber-reinforced polymer. For instance, in some examples, the tie member 18 is comprised of basalt-fiber and preferably, the tie member 18 is composed of basalt fiber in an amount of at least 50% by volume. The elongated tie member 18 may have a wave shape, and in particular a sinusoidal wave shape. The tie member 18 may have crests 30 and troughs 32 having a wave height defined between the crests 30 and the troughs 32. The tie member 18 is configured for the crests 30 to extend into the second concrete layer 14 and the troughs 32 to extend into the first concrete layer 12.

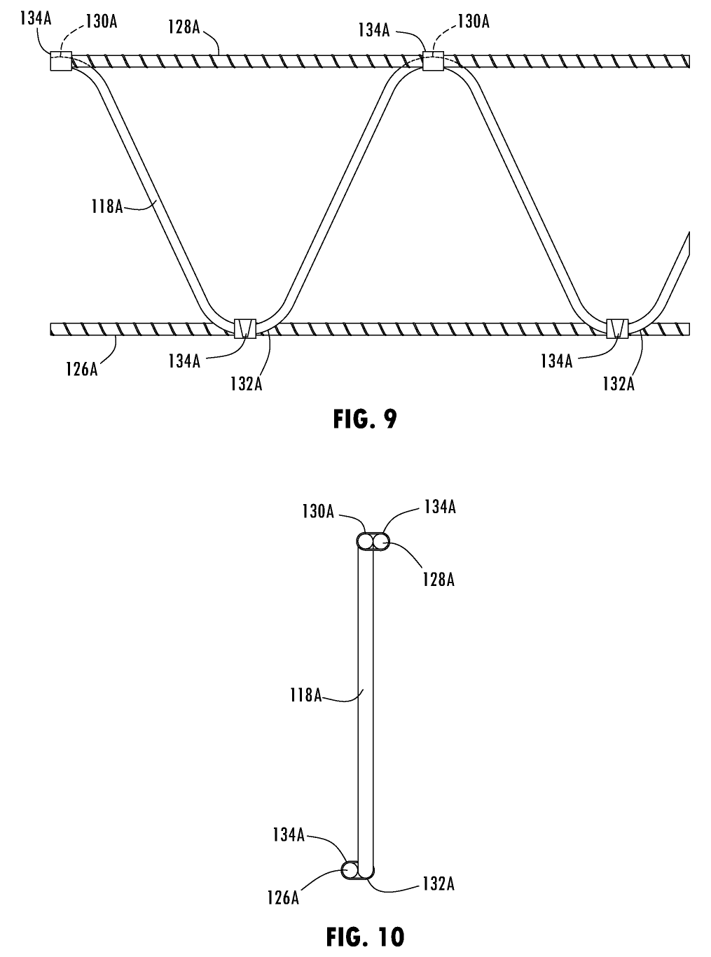

As illustrated in FIGS. 1 and 2, the first reinforcing structure 26 may be generally aligned with the troughs 32 of the tie member 18 such that the first reinforcing structure 26 and the troughs 32 are generally positioned at the same depth in the first layer of concrete 12. The second reinforcing structure 28 may be generally aligned with the crests 30 of the tie member 18 such that the second reinforcing structure 28 and the crests 30 are generally positioned at the same depth in the second layer of concrete 14. In some examples, the elongated tie member 18 may include attachment structures 34 that are non-welded forms of engagement for supporting the first and second reinforcing structures 26, 28 along the elongated tie member 18. The attachment structures 34 are configured to engage the dual material interface defined by the non-metal material of the tie member and the metal reinforcing structures. The attachment structures 34 may, in some examples, be a tie for receiving and/or engaging a portion of the tie member 18 and a portion of the reinforcing structures 26, 28. The tie may be a piece of metal wire wrapped around and, in some examples, twisted to hold its ends together around the tie member and reinforcing structures. In additional examples, the tie may be a zip tie or other form of tie, such as shown in FIGS. 9-14. In some embodiments, the attachment structures 34 may be configured to tighten the reinforcing structure 26, 28 to the tie member 18 to restrict or prevent movement of the tie member 18 relative to the reinforcing structures 26, 28. For example, the tie member 18 may have multiple attachment structures 34 to attach the tie member 18 at or near each crest 30 to the second reinforcing structure 28 and a multiple attachment structures 34 to attach the tie member 18 at or near each trough 32 to the first reinforcing structure 26.

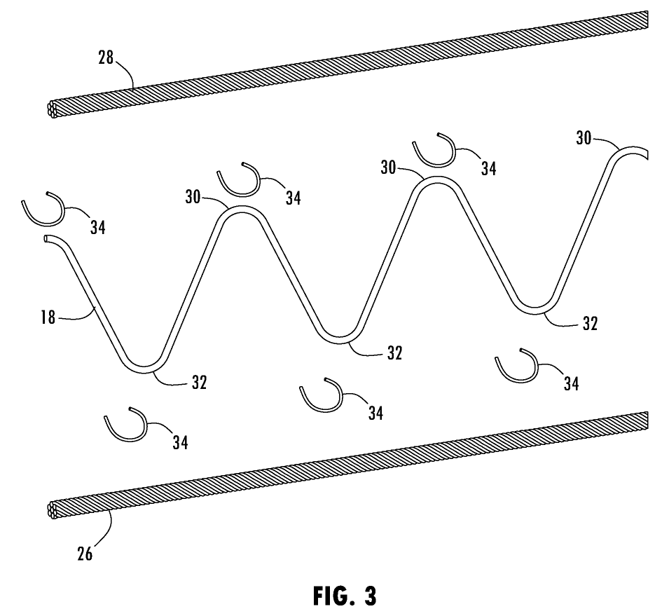

Referring to FIG. 3, a schematic view of the insulating layer 16 is illustrated. The insulating layer 16 includes the elongated tie member 18, the first insulating panel 20, and the second insulating panel 22. The insulating layer 16 is comprised of the first and second insulating panels 20, 22 extending side-by-side and being compressed to form the vertical seam 24. The insulating panels 20, 22 are compressed around the elongated tie member 18 to maintain contact with the tie member 18 and the other of the insulating panels 20, 22 in the vertical seam 24. In this way, the first and second insulating panels 20, 22 compress around or substantially around the circumference of the elongated tie member 18 in the vertical seam 24, maintaining constant contact and preventing or minimizing space or gaps in the insulating layer 16.

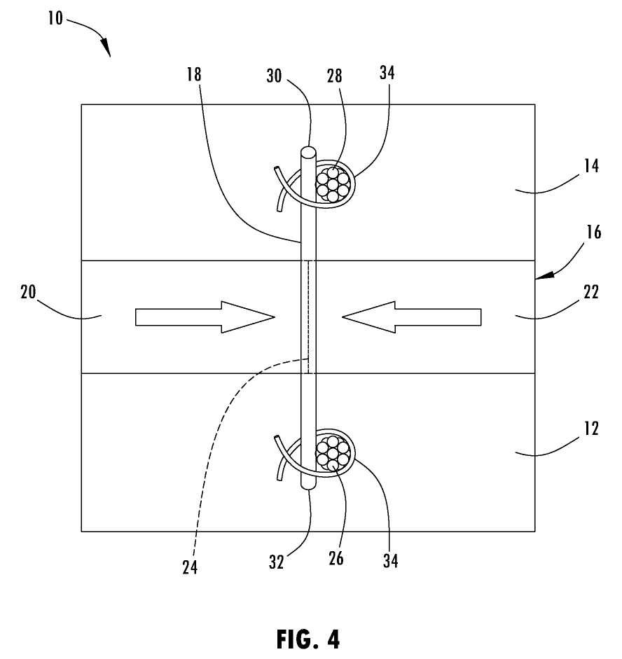

Referring to FIG. 4, an end view of the concrete sandwich panel 10 is illustrated showing the compression of the first insulating panel 20 and the second insulating panel 22 along the vertical seam 24. The insulating panels 20, 22 are compressed around the elongated tie member 18 which is disposed in the vertical seam 24. The insulating panels 20, 22 compress around the elongated tie member 18, maintaining contact between the first and second tie insulating panels 20, 22 to prevent gaps in the insulating layer 16. Also, as illustrated in FIG. 4, the second reinforcing structure 28 is configured to attach to the tie member 18 approximate the crests 30 of the tie member’s 18 wave shape. The second reinforcing structure 28 and the crests 30 are disposed in the second layer of concrete 14 at a pre-defined location along the length of the sandwich panel 10. Thus, allowing the reinforcement structure to be placed within the concrete layer in a controlled and replicable manner to be able to produce a sandwich panel with reliable and predictable strength properties based on the consistent location and depth of the reinforcement in the concrete. Similarly, the first reinforcing structure 26 is configured to attach to the tie member 18 approximate the troughs 32 of the tie member’s 18 wave shape. The first reinforcing structure 26 and the troughs 32 are disposed in the first layer of concrete 12 at a pre-defined location along the length of the sandwich panel 10 to create reliable strength properties of the concrete 12 based on the pre-defined depth of the reinforcement structure 26 along the length of the panel 10.

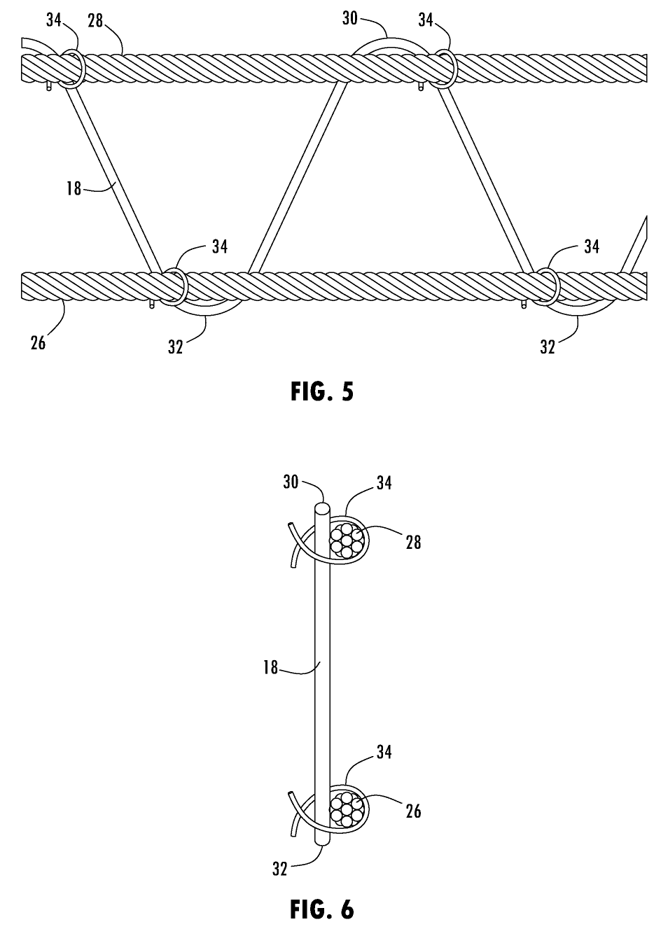

Referring to FIGS. 5 and 6, the elongated tie member 18 is attached to the first reinforcing structure 26 and the second reinforcing structure 28. The elongated tie member 18 is configured to extend at least from a first concrete layer to a second concrete layer. The first reinforcing structure 26 and the second reinforcing structure 28 are configured to cooperate with the tie member 18 to position the tie 18 and structures 26, 28 at a pre-defined embedment level in the first and second layers of concrete. The tie member 18 is preferably composed of fiber-reinforced polymer. According to one embodiment, the tie member 18 is preferably composed of basalt fiber resin, for example pultruded basalt fiber resin. The tie member 18 may be composed of any suitable amount of basalt resin. Preferably, the tie member 18 is composed of basalt fiber in an amount of at least 50% by volume.

The elongated tie member 18 is preferably a wave-shaped tie member 18 that includes alternating crests 30 and troughs 32. As shown in FIGS. 2 and 5, the tie member 18 may include waved portions having any suitable shape or configuration that is arranged to dispose a portion of the elongated tie member 18 in one concrete layer and another portion of the elongated tie member 18 in the opposite concrete layer of the sandwich panel. For example, the tie member 18 may be zig-zagged, wavy, or sinusoidal in shape. In one embodiment, successive troughs 32 are preferably configured to be disposed in a first concrete layer and successive crests 30 are preferably configured to be disposed in a second concrete layer of the sandwich panel. Preferably, the tie member 18 comprises a wave configuration in which the waves are regular in pitch and wavelength along the length of the tie member 18. It is, however, understood that the wave portions of the tie member 18 may be irregular in pitch and/or wavelength and/or shape along the length of the tie member. The first reinforcing structure 26 and the second reinforcing structure 28 may be configured as a pre-stressed cable. The first reinforcing structure 26 may be a straight cable extending along the length of the elongated tie member 18 and attached to the tie member 18 approximate the troughs 32. For example, an attachment structure 34 may secure the first reinforcing structure 26 to the tie member 18 at each of the troughs 32. The attachment structure 34 may be a tie structure that wraps around the reinforcing structure 26 and tightens the reinforcing structure 26 against the tie member 18. Similarly, the second reinforcing structure 28 may be a straight cable extending along the length of the elongated tie member 18 and attached to the tie member 18 approximate the crests 30. For example, an attachment structure 34 may secure the second reinforcing structure 28 to the tie member 18 at each of the crests 30. The attachment structure 34 may be a tie structure that wraps around the reinforcing structure 28 and tightens the reinforcing structure 28 against the tie member 18.

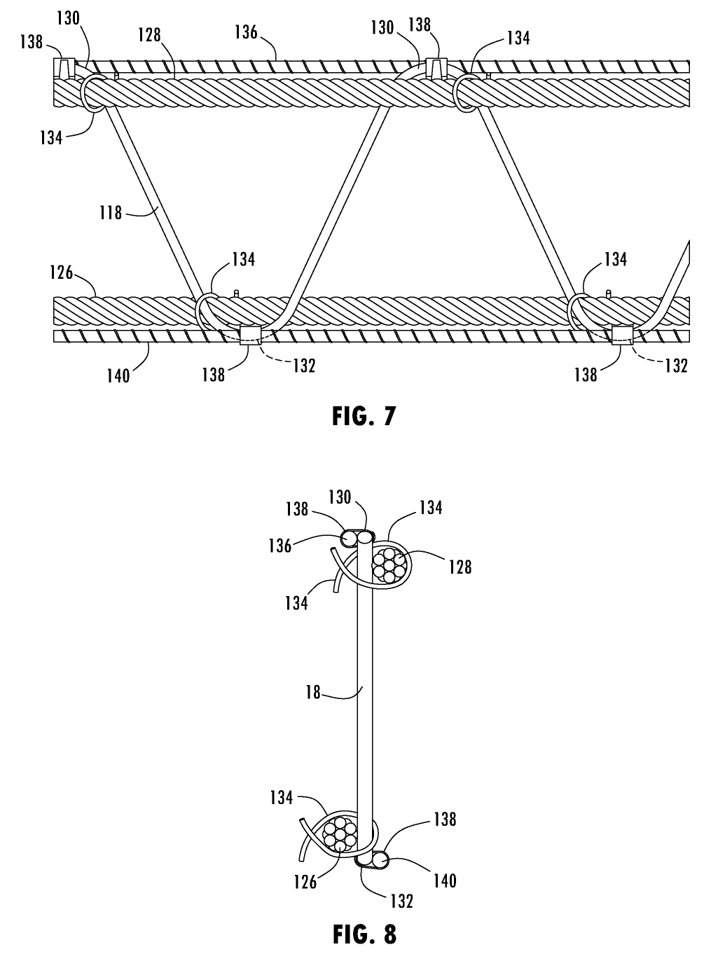

Referring to FIGS. 7 and 8, a second example of an elongated tie member 118 is illustrated having a wave-shaped tie member 118, an upper wire member 136, or a first horizontal tie member, and a lower wire member 140, or a second horizontal tie member, each of which extends along the length of the tie member 118. The elongated tie member 118 is attached to the first reinforcing structure 126 and the second reinforcing structure 128. The elongated tie member 118 is configured to extend at least from a first concrete layer to a second concrete layer. The first reinforcing structure 126 and the second reinforcing structure 128 are configured to cooperate with the tie member 118 to position the tie 118 and structures 126, 128 at a pre-defined embedment level in the first and second layers of concrete. The tie member 118 and corresponding upper and lower wire members 136, 138, is preferably composed of fiber-reinforced polymer. According to one embodiment, the tie member 118 is preferably composed of basalt fiber resin, for example pultruded basalt fiber resin. The tie member 118 may be composed of any suitable amount of basalt resin. Preferably, the tie member 118 is composed of basalt fiber in an amount of at least 50% by volume.

Like the embodiment shown in FIGS. 1-6, the tie member 118 shown in FIG. 7 may comprise waved portions having any suitable shape or configuration that is arranged to dispose a portion of the elongated tie member 118 in one concrete layer and another portion of the elongated tie member 118 in the opposite concrete layer of the sandwich panel. For example, the tie member 118 may be zig-zagged, wavy, or sinusoidal in shape. In one embodiment, successive troughs 132 are preferably configured to be disposed in a first concrete layer and successive crests 130 are preferably configured to be disposed in a second concrete layer of the sandwich panel. Preferably, the tie member 18 comprises a wave configuration in which the waves are regular in pitch and wavelength along the length of the tie member 118. It is however to be understood that the wave portions of the tie member 18 may be irregular in pitch and/or wavelength and/or shape along the length of the tie member. The first reinforcing structure 126 and the second reinforcing structure 128 may be configured as a pre-stressed cable. The first reinforcing structure 126 may be a straight cable extending along the length of the elongated tie member 118 and attached to the tie member 118 adjacent to the troughs 132. For example, an attachment structure 134 may secure the first reinforcing structure 126 to the tie member 118 at each of the troughs 132. The attachment structure 134 may be a tie structure that wraps around the reinforcing structure 126 and tightens the reinforcing structure 126 against the tie member 118. Similarly, the second reinforcing structure 128 may be a straight cable extending along the length of the elongated tie member 118 and attached to the tie member 118 adjacent to the crests 130. For example, an attachment structure 134 may secure the second reinforcing structure 128 to the tie member 118 at each of the crests 130. The attachment structure 134 may be a tie structure that wraps around the reinforcing structure 128 and tightens the reinforcing structure 128 against the tie member 118.

With further reference to FIGS. 7 and 8, the upper wire member 136 may be formed of the same material as the tie member 118. For example, the upper wire member 136 may be preferably comprised of a basalt fiber resin. The upper wire member 136 may be attached to the tie member 118 at the crests 130. For example, the upper wire member 136 may be attached at each of the crests 130 by a clip 138 or other attachment structure. The lower wire member 140 may be formed of the same material as the tie member 118. For example, the lower wire member 140 may be preferably comprised of a basalt fiber resin. The lower wire member 140 may be attached to the tie member 118 at the troughs 132. For example, the lower wire member 140 may be attached at each of the troughs 132 by a clip 138 or other attachment structure. The upper and lower wire members 136, 140 extend parallel to each other along the length of the tie member 118 and may be configured to add further stability and structure to the tie member 118.

As shown in FIGS. 9-14, additional examples are illustrated showing alternative attachment structures that are used to secure the reinforcing structures to the tie member at each of the troughs and crests. For example, as shown in FIGS. 9 and 10, the attachment structures 134A may be a clasp structure that wraps around one of the reinforcing structures 126A, 128A and tightens the reinforcing structure 126A, 128A against the tie member 118A. The reinforcing structures 126A, 128A may be straight structures, such as pretensioned rods or cables, extending along the length of the elongated tie member 118A and attached to the tie member 118A adjacent to the crests 130A and troughs 132A. The attachment structures 134A secure the reinforcing structures 126A, 128A to the tie member 118A at each of the crests 130A and troughs 132A. The attachment structures 134A as the clasp structures may be a metal band that is crimped around a single reinforcing structure 126A, 128A and the tie member 118A.

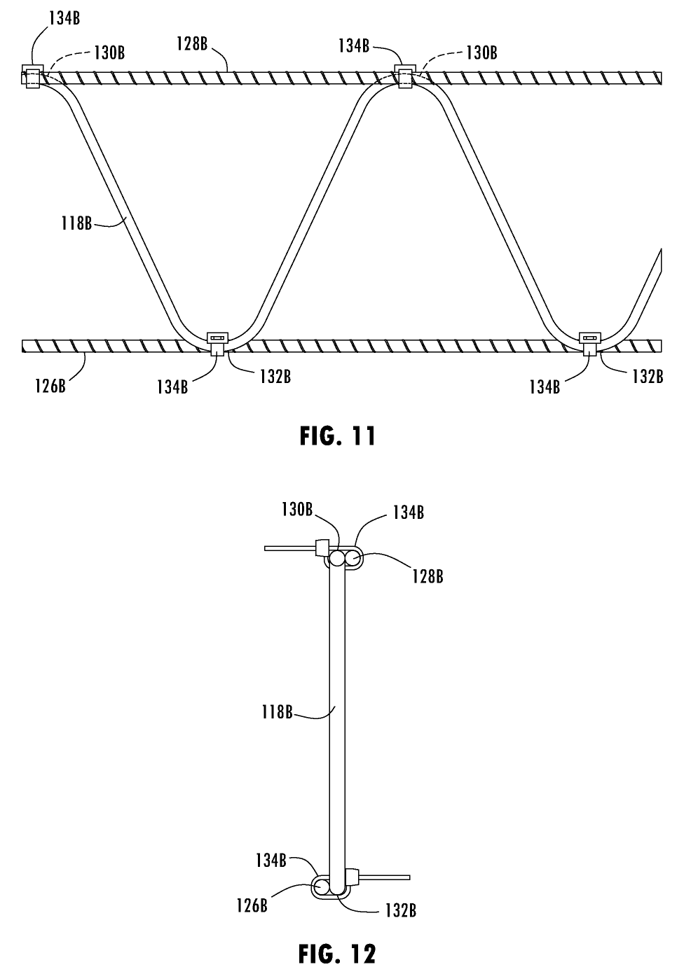

As shown in FIGS. 11 and 12, an additional example of the attachment structures 134B may be a zip-tie structure that wraps around one of the reinforcing structures 126B, 128B and tightens the reinforcing structure 126B, 128B against the tie member 118B. The reinforcing structures 126B, 128B may be straight structures, such as pretensioned rods or cables, extending along the length of the elongated tie member 118B and attached to the tie member 118B adjacent to the crests 130B and troughs 132B. The attachment structures 134B secure the reinforcing structures 126B, 128B to the tie member 118B at each of the crests 130B and troughs 132B. The attachment structures 134B as the zip-tie structures may be a notched plastic strap that is fed through a housing that engages the notches to form a secure hold around a single reinforcing structure 126B, 128B and the tie member 118B.

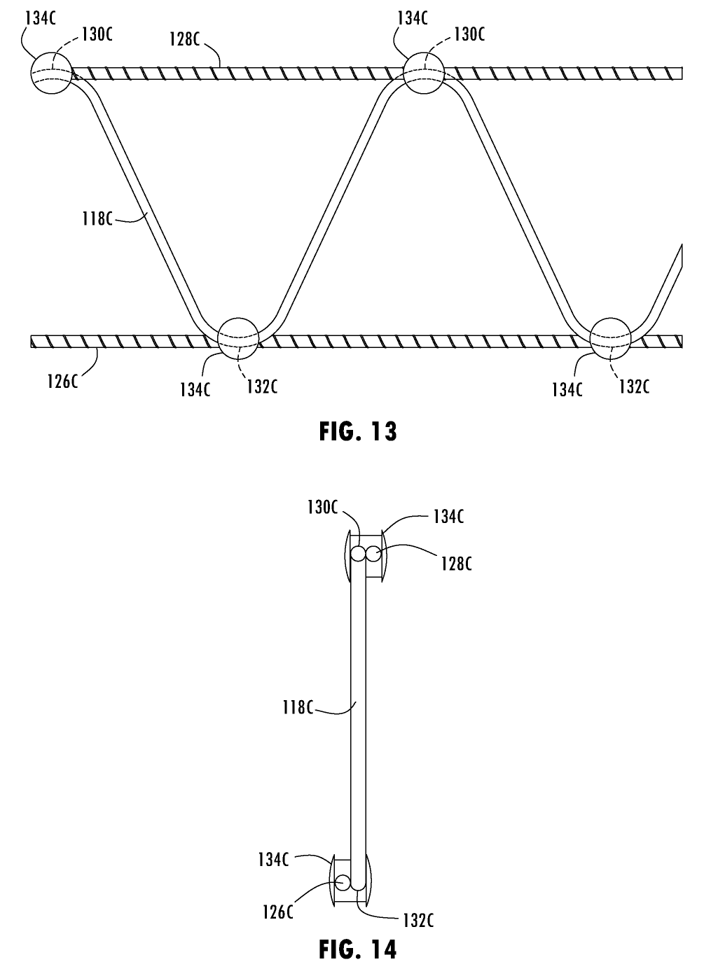

As shown in FIGS. 13 and 14, an additional example of the attachment structures 134C may be a molded containment structure that wraps around one of the reinforcing structures 126C, 128C and tightens the reinforcing structure 126C, 128C against the tie member 118C. The reinforcing structures 126C, 128C may be straight structures, such as pretensioned rods or cables, extending along the length of the elongated tie member 118C and attached to the tie member 118C adjacent to the crests 130C and troughs 132C. The attachment structures 134C secure the reinforcing structures 126C, 128C to the tie member 118C at each of the crests 130C and troughs 132C. The attachment structures 134C as the molded containment structures may be a two-piece assembly that laterally engage to form a secure hold around a single reinforcing structure 126C, 128C and the tie member 118C.

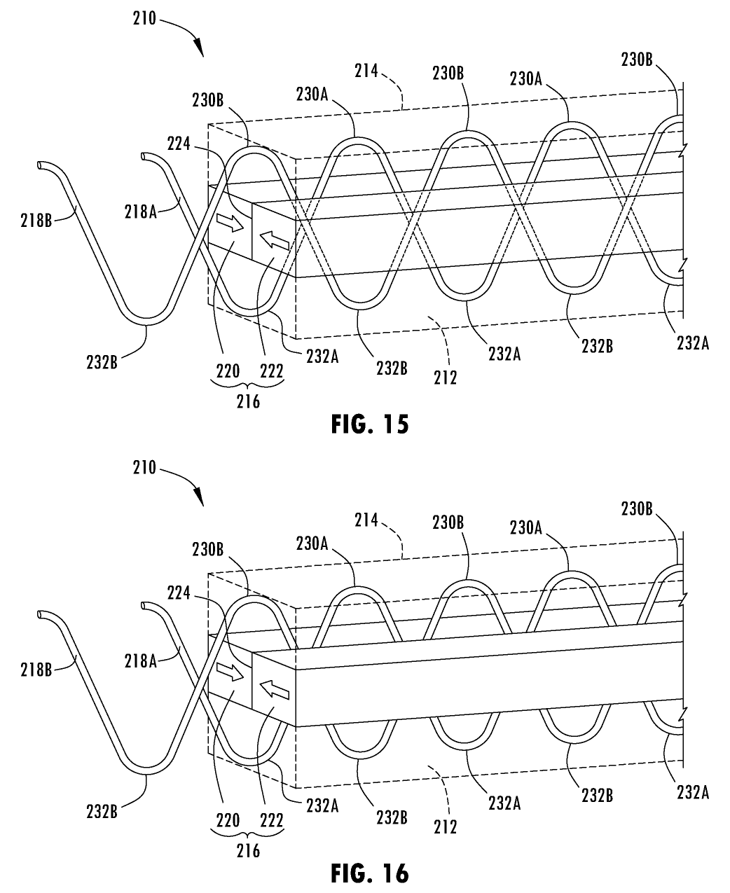

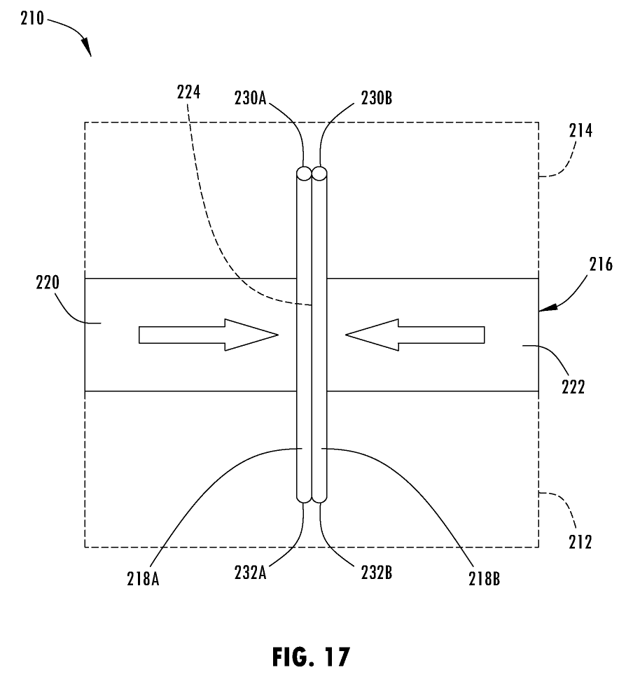

Referring to FIGS. 15-17, an exemplary insulating panel 216 is illustrated with a first elongated tie member 218A and a second elongated tie member 218B. The insulating layer 216 may include the first and second elongated tie members 218A, 218B surrounded by a first insulating panel 220 and a second insulating panel 222. The first and second insulating panels 220, 222 may extend side-by-side and be compressed against each other defining a vertical seam 224 between the insulating panels 220, 222. The first insulating panel 220 may be compressed along a first side of the first elongated tie member 218A and the second insulating panel 222 may be compressed along a second side of the second elongated tie member 218B, resulting in the first and second tie members 218A, 218B being disposed at least partially in the vertical seam 224. The insulating panels 220, 222 are compressed around the elongated tie members 218A, 218B to maintain contact with both of the tie members 218A, 218B and the other of the insulating panels 220, 222 in the vertical seam 224. In this way, the first and second insulating panels 220, 222 compress around the circumference of the elongated tie members 218A, 218B in the vertical seam 224, maintaining constant contact and preventing or minimizing space or gaps in the insulating layer 216.

In some examples, the first and second elongated tie members 218A, 218B may each be comprised one member extending along the length of the insulating panel 216. In other examples, the each of the first and second elongated tie members may be comprised of two or more elongated tie members which may be connected or otherwise disposed end-to-end to extend the length of the reinforcement in a sandwich panel. The first and second elongated tie members 218A, 218B may be comprised of basalt-fiber and preferable, the tie members 218A, 218B may be composed of basalt-fiber in an amount of at least 50% by volume. The elongated tie members 218A, 218B may have a wave shape, and in particular a sinusoidal wave shape. The first elongated tie member 218A and the second elongated tie member 218B may have the same amplitude, but be provided at opposite phases of the waves. For example, the first tie member 218A may have alternating crests 230A and troughs 232A and the second tie member 218B may have alternating crests 230B and troughs 232B. The first elongated tie member 218A and the second elongated tie member 218B may be positioned such that the crests 230A of the first elongated tie member 218A are vertically aligned with the troughs 230B of the second elongated tie member 218B and the troughs 232A of the first elongated tie member 218A are vertically aligned with the crests 232B of the second elongated tie member 218B. The first and second elongated tie members 218A, 218B may have a wave height such that the crests 230A, 230B are configured to extend into a second concrete layer and the troughs 232A, 232B are configured to extend into a first concrete layer as described in the above examples. The first and second elongated tie members 218A, 218B may be configured to be attached to reinforcing structures in the first and second concrete layers as discussed in the above described examples.

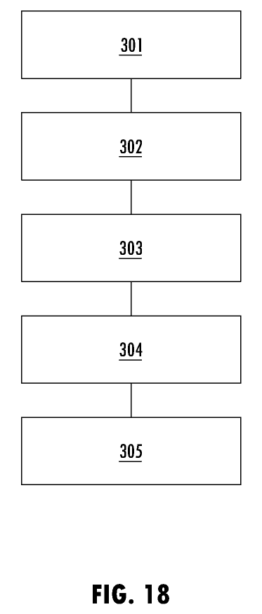

Referring to FIG. 18, a flow chart illustrating a method of producing a reinforced concrete panel is provided. At 301, an insulating tie layer is produced. The insulating tie layer is formed by compressing a first insulating panel along a first side of a tie member and compressing a second insulating panel along a second side of a tie member. The first insulating panel and the second insulating panel are compressed such that they form a vertical seam in which the tie member is at least partially disposed. The insulating panels are compressed around the elongated tie member to maintain contact with one another along the vertical seam. For example, the first and second insulating panels are compressed around the circumference of the elongated tie member in the vertical seam to prevent or reduce gaps or spaces within the insulating tie members.

At 302, a first reinforcing structure is attached to the tie member along the troughs of the tie member and a second reinforcing structure is attached to the tie member along the crests of the tie member. In this step, the reinforcing structures may be coupled to the insulating tie layer via attachment structures such as ties. At 303, a first concrete layer may be formed by pouring a first layer of concrete into a mold. At 304, the insulating tie layer is positioned on top of the first layer of concrete before the concrete fully cures such that the first reinforcing structure and the troughs of the tie member may be disposed in the first layer of concrete. As the layer of concrete cures with the reinforcing structure and the tie member, a first reinforced concrete layer is produced. At 205, a second layer of concrete is poured on top of the insulating tie member, such that the second reinforcing structure and the crests of the tie member are positioned in the second layer of concrete, thus forming a second reinforced concrete layer. The sandwich panel is then cured to provide a strong and pre-formed two-layered concrete module with a sandwiched layer of insulation.

Thus, according to the disclosure, a concrete sandwich panel includes a first reinforced concrete layer, a second reinforced concrete layer, an insulating layer disposed between the first reinforced concrete layer and the second reinforced concrete layer, and an elongated tie member. The insulating layer includes a first panel and a second panel that are divided by a vertical seam. The elongated tie member includes a wave shape that has alternating crests and troughs. A wave height of the tie member is configured for the crests to extend into the first reinforced concrete layer and the troughs to extend into the second reinforced layer. The elongated tie member is disposed in the vertical seam with at least one of the first or second panels compressed around the elongated tie member to maintain contact of the first and second panels along the vertical seam.

Also according to the disclosure, an anchoring system for a reinforced concrete sandwich panel includes a first layer of concrete provided with a first reinforcing rod and a second layer of concrete provided with a second reinforcing rod, a tie member and an insulation layer disposed between the first layer of concrete and the second layer of concrete. The tie member has a sinusoidal shape extending at least into the first layer of concrete and the second layer of concrete. The insulation layer has a first insulating panel extending along the length of a tie member on a first side and a second insulating panel extending along the length of a tie member on a second side, opposite the first side. The tie member includes at least one attachment structure securing the tie member to the first reinforcing rod or the second reinforcing rod.

Also according to the disclosure, a method for producing a concrete sandwich panel includes compressing a first insulating panel along a first side of a tie member and a second insulating panel along a second side of a tie member to produce an insulating tie layer, attaching a bottom reinforcing structure and a top reinforcing structure to the tie member, pouring a first layer of concrete into a mold, disposing the insulating tie layer on top of the first layer of concrete and positioning the bottom reinforcing structure in the first layer of concrete to produce a first reinforced concrete layer, and pouring a second layer of concrete on top of the insulating tie member and positioning the top reinforcing structure in the second layer of concrete to produce a second reinforced concrete layer.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A concrete sandwich panel comprising:
a first reinforced concrete layer;
a second reinforced concrete layer;
an insulating layer disposed between the first reinforced concrete layer and the second reinforced concrete layer, the insulating layer including a first panel and a second panel that are divided by a vertical seam; and
an elongated tie member having a wave shape comprising a plurality of crests and a plurality of troughs, wherein a wave height of the elongated tie member is configured for the plurality of troughs to extend into the first reinforced concrete layer and the plurality of crests to extend into the second reinforced concrete layer,
wherein the elongated tie member is disposed in the vertical seam with at least one of the first or second panels compressed around the elongated tie member to maintain contact of the first and second panels along the vertical seam.

2. The concrete sandwich panel of claim 1, further comprising an upper wire member extending along a length of the elongated tie member and connected to the elongated tie member at the plurality of crests.

3. The concrete sandwich panel of claim 1, further comprising a lower wire member extending along a length of the elongated tie member and connected to the elongated tie member at the plurality of troughs.

4. The concrete sandwich panel of claim 1, wherein a first reinforcing structure is disposed in the first reinforced concrete layer and a second reinforcing structure is disposed in the second reinforced concrete layer.

5. The concrete sandwich panel of claim 4, wherein the first reinforcing structure and the second reinforcing structure are attached to the elongated tie member and extend along a length of the elongated tie member.

6. The concrete sandwich panel of claim 5, wherein the elongated tie member includes a plurality of attachment structures for supporting the first reinforcing structure and the second reinforcing structure along the elongated tie member.

7. The concrete sandwich panel of claim 5, wherein the first reinforcing structure is generally aligned with the plurality of troughs.

8. The concrete sandwich panel of claim 5, wherein the second reinforcing structure is generally aligned with the plurality of crests.

9. The concrete sandwich panel of claim 4, wherein the first reinforcing structure and the second reinforcing structure are pre-stressed cables.

10. The concrete sandwich panel of claim 1, wherein the elongated tie member is a fiber-reinforced polymer.

11. The concrete sandwich panel of claim 10, wherein the elongated tie member comprises a basalt fiber in an amount of at least 50% by volume.

12. The concrete sandwich panel of claim 1, wherein the first and second panels are compressed around a circumference of the elongated tie member.

13. An anchoring system for a reinforced concrete sandwich panel, comprising:
a first layer of concrete provided with a first reinforcing rod and a second layer of concrete provided with a second reinforcing rod;
a tie member having a sinusoidal shape extending at least into the first layer of concrete and the second layer of concrete; and
an insulation layer disposed between the first layer of concrete and the second layer of concrete having a first insulating panel extending along a length of the tie member on a first side and a second insulating panel extending along the length of a tie member on a second side, opposite the first side,
wherein the tie member includes at least one attachment structure securing the tie member to the first reinforcing rod or the second reinforcing rod.

14. The anchoring system of claim 13, wherein the tie member comprises a fiber-reinforced polymer.

15. The anchoring system of claim 14, wherein the first reinforcing rod and the second reinforcing rod each comprise a pre-stressed metal cable.

16. The anchoring system of claim 15, wherein the tie member includes a plurality of attachment structures configured to support the first and second reinforcing rods at the tie member.

17. The anchoring system of claim 13, further comprising a first horizontal tie member and a second horizontal tie member, the first horizontal tie member and the second horizontal tie member extending along the length of the tie member.

18. The anchoring system of claim 17, wherein the first horizontal tie member is attached to the tie member at a plurality of troughs of the sinusoidal shape and is disposed at least partially in the first layer of concrete, and wherein the second horizontal tie member is attached to the tie member at a plurality of crests of the sinusoidal shape and is disposed at least partially in the second layer of concrete.

19. A concrete sandwich panel comprising:
a first reinforced concrete layer;
a second reinforced concrete layer;
an insulating layer disposed between the first reinforced concrete layer and the second reinforced concrete layer; and
an elongated tie member having a wave shape comprising a plurality of troughs disposed in the first reinforced concrete layer and a plurality of crests disposed in the second reinforced concrete layer, the tie member comprises a fiber-reinforced polymer,
wherein the first reinforced concrete layer comprises a first prestressed reinforcement and the second reinforced concrete layer comprises a second prestressed reinforcement, and
wherein a plurality of attachment structures attach the tie member to the first and second prestressed reinforcements.

20. The concrete sandwich panel of claim 19, wherein the insulating layer includes a first panel and a second panel that are divided by a vertical seam, and wherein the elongated tie member is disposed in the vertical seam with at least one of the first or second panels compressed around the elongated tie member to maintain contact of the first and second panels along the vertical seam.
